(19) United States
(12) Patent Application Publication
(10) Pub. No.: US 2024/0135810 A1
(43) Pub. Date: Apr. 25, 2024

(54) Traffic 2.0

(71) Applicant: Kordell Williams, Byram, MS (US)

(72) Inventor: Kordell Williams, Byram, MS (US)

(21) Appl. No.: 17/971,674

(22) Filed: Oct. 23, 2022

(51) Int. Cl. G08G 1/095

(52) U.S. Cl. CPC G08G 1/095

(57) ABSTRACT

The invention involves a novel form of traffic signal system which is equipped with the latest technology chips. It will be having multiple functions which are to be helpful to pedestrians and vehicles. These features include but are not limited to updated traffic systems which will be better enhanced and help the pedestrians with different kinds of information like News, Temperature, and speaker information. The assembly is easy to install, runs on kinetic energy, runs on solar panels and also has backup batteries to continue its non-stop performance.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

A method and system for providing an innovative traffic light is disclosed. The product is a traffic light system that includes speakers to give information to the onlookers with current climate/time information, a three lights system in the center where it will work like regular traffic lights like Yellow, Green and Red. The traffic light panel will also have a 180-degree camera and the passersby will be giving the kinetic energy to the panel while moving around as it will be having pads to generate kinetic energy to power up.

### Description of the Related Art

With the rapid development of economy and the continuous promotion of urbanization process in world, the quantity of automobiles kept is rapidly increased, the problems of traffic safety and congestion become increasingly prominent problems, and the traditional solving means has the defects of incomplete information detection and insufficient sharing, so that the current situation is still not optimistic.

For example, Taylor, U.S. Pat. No. 7,865,309 discloses a system in which geographic coordinate data is used as a principal criterion for implementing wireless transmitted instructions and communications advising vehicles of an approaching emergency vehicle, the proximity of a hazardous condition, or other situations relevant to the intended recipient because of the recipient's location. This patent also describes intervention and control of a vehicle that comes into a predetermined location. The system uses transmitting units and receiving units, both of which can receive geographical positioning information and which may sound an appropriate advisory or warning based on their positions, heading, or speed. Geographic location of the intended recipient, or target, and its heading or speed, if desired, are used as a screen or filter for the delivery or the broadcast of an advisory.

Kato et al., U.S. Pat. No. 7,439,878 discloses a vehicle navigation system for use with a traffic information broadcast system. The broadcast system transmits traffic data relating to primary road segments in a local geographic area. A broadcast receiver receives the broadcast traffic data from the broadcast system and stores the received data. A communication transmitter, when activated, transmits a data request to the communication system. A communication receiver receives the local traffic data from the communication system in response to the data request while a processor displays traffic information on a display screen corresponding to the received broadcast traffic data and the received local traffic data.

Burns, U.S. Published Patent Application 2002/0121989 describes a system for providing personalized traffic alerts to a user by automatic processing of vehicle position and traffic alert conditions. The system employs at least one user portion and a server portion, wherein the server portion provides the user portion with traffic alert information. The user portion includes a receiver, a position locator, a processor, a memory storage area, and an output device. The processor calculates the vehicle trajectory and in addition, the processor can predict the vehicle route based on the calculated vehicle trajectory, and historical routes in the memory storage area. The processor also correlates relevant traffic alerts by comparing the traffic alert information with the calculated vehicle trajectory or the predicted vehicle route.

Park et al., U.S. Pat. No. 6,336,075 discloses a system for guiding a vehicle, in which a transmission signal of a position transmitting device (with the transmitters being installed at key points on a roadside) is received by a position receiving device mounted in the vehicle. The system includes units for coding position information on the road where the position transmitting device is installed, along with traffic information such as warning information with respect to the road. The units store this information, modulate the information and continuously transmit the coded information to the vehicle.

A U.S. Pat. No. 8,232,896 claims a traditional pedestrian signal housing with a video display screen mounted to a pedestrian side of the traditional pedestrian signal housing is disclosed. This invention claims a video display screen is mounted to the pedestrian side of the pedestrian signal housing by way of a face plate. This invention claims tunnel visors may be attached to the traditional pedestrian signal housing to prevent cross traffic from being distracted by the visual images displayed on the video display screen. This invention claims the information displayed on the video display screen may be advertisements, information, directions, etc. Local or national entities may pay for advertisements to generate revenues for the cities or governmental entities.

Improved traffic monitoring and control and implementation of a state-of-the-art traffic management and control system could reduce traffic accidents and traffic-related deaths and improve traffic management.

There are multiple solutions that have been presented in the prior art. However, these solutions are limited and restricted to their conventional architecture, and installation system and have considerable shortcomings which adversely affect the convenience with which they can be used. The prior systems have certain limitations including the design of assemblies which make them not suitable for every type of user. Moreover, the ease-of-use ability of these assemblies is also questionable. The current invention proposes an advancement in a similar domain where a traffic signal system with various exemplary features is disclosed. The current invention relates to the method and system for providing a realistic environment for a traffic report is disclosed. The traffic report includes a 3D view of current traffic conditions for one or more roadways in and around a metropolitan area. The 3D view includes a background that reflects the current time of day and/or weather conditions. For example, a traffic report shown by a television station as part of the evening news may depict the background as having a dark sky and nighttime lighting, such as vehicle, building, and street lights. As another example, a traffic report shown by a television station as part of the noon news may depict the background as having overcast skies. US: 20100070175

A traffic light detection system for a vehicle is also provided. The system may include at least one processing device programmed to receive, from at least one image capture device, a plurality of images representative of an area forward of the vehicle, the area including a traffic light fixture having at least one traffic light. The at least one processing device may also be programmed to analyze at least one of the plurality of images to determine a status of the at least one traffic light, and determine an estimated amount of time until the vehicle will reach an intersection associated with the traffic light fixture. The at least one processing device may further be programmed to cause a system response based on the status of at least one traffic light and the estimated amount of time until the vehicle will reach the intersection.

One aspect of the present disclosure provides a method. This method involves checking the time at which the traffic signal light changes from yellow to red by one or more computing devices and the estimated time at which the traffic signal light changes from yellow to red by one or more computing devices. Estimating the position, confirming the starting point of the intersection associated with the traffic light with one or more computing devices, and estimating the position of the vehicle past the starting point with one or more computing devices. Determining whether the vehicle is at least a threshold distance, and when the estimated position of the vehicle is determined to be at least the threshold distance past the starting point, the vehicle passes through the intersection by one or more computing devices. Determining that it should continue.

The present application discloses embodiments that relate to detection of light indicators in an image or video captured by an image-capture device coupled to an autonomous vehicle. In one aspect, the present application describes a method. The method includes receiving, from the image-capture device coupled to the autonomous vehicle, an image that includes a light indicator. The light indicator includes an illuminated component. Additionally, the method includes determining, from the received image, a color of the illuminated component of the light indicator and an associated confidence level of the determination of the color of the illuminated component.

The method also includes determining, from the received image, a shape of the illuminated component of the light indicator and an associated confidence level of the determination of the shape of the illuminated component.

The method also includes determining a characteristic of a state of the light indicator based on at least one of the confidence levels of the determination of the color and the confidence level of the determination of the shape exceeding a threshold value. Further, the method includes providing instructions executable by a computing device to control the autonomous vehicle based on the determined characteristic of the state of the light indicator.

Drivers use visual clues to estimate when a traffic light will change color. Some drivers will speed up the vehicle when the traffic light is green to clear the intersection before the light changes to yellow or red. Seeing a traffic light turn yellow prior to reach the intersection will likely cause the driver to slow the vehicle in anticipation of the traffic light turning red. Drivers can use other visual clues from the traffic light, such as a left-turn arrow, to guess when the traffic light will change.

An exemplary autonomous vehicle includes at least one autonomous driving sensor configured to detect a traffic flow pattern relative to an intersection. The traffic flow pattern suggests a state of a traffic control device and may include a cross-walk signal, the movement of traffic through an intersection, or the like. An autonomous mode controller is configured to determine the state of the traffic control device.

The autonomous mode controller may further estimate when the state of the traffic control device is likely to change based on the traffic flow pattern. By anticipating when the state of the traffic control device is likely to change, the autonomous vehicle may conserve fuel economy, reach a destination in the same or less time than a human driver, drive in a smoother more refined manner or any combination thereof.

As technology continues to advance, more and more vehicles are equipped with sensors and driving assistance systems configured to assist the driver in safe driving. Such driving assistance systems may use cameras to capture images of the road environment surrounding the vehicle. The driving assistance systems analyze the images to identify pedestrians, road signs, traffic lights, etc., and provide warnings to the drivers. As another example, fully autonomous vehicles are being developed that can automatically navigate on the roads without driver input. Autonomous vehicles may take into account a variety of factors and make appropriate decisions based on those factors to safely and accurately reach an intended destination. For example, an autonomous vehicle may need to process and interpret visual information (e.g., images captured by a camera) and may also use information obtained from other sources (e.g., from a GPS device, a speed sensor, an accelerometer, a suspension sensor, etc.).

When a conventional or an autonomous vehicle approaches a traffic intersection, the driver or the vehicle itself may need to make a decision as to whether the vehicle should stop or whether the vehicle should proceed to safely past the traffic intersection. Sometimes drivers do not pay close attention to the status of traffic lights ahead of the vehicle. In the case of autonomous vehicle, it is still a challenging task for the autonomous vehicle to accurately determine whether it would be safe to pass an intersection based on information collected from various sensors. Therefore, it is desirable and a modern trend to equip vehicles (whether conventional or autonomous) with a system that can detect the status of the traffic light and make an appropriate and timely decision on what actions the vehicles or drivers should take in order to avoid collision at the intersection.

As technology continues to advance, the goal of a fully autonomous vehicle that is capable of navigating on roadways is on the horizon. Primarily, an autonomous vehicle may be able to identify its environment and navigate without input from a human operator. Autonomous vehicles may also take into account a variety of factors and make appropriate decisions based on those factors to safely and accurately reach an intended destination. For example, various objects-such as other vehicles and pedestrians—are encountered when a vehicle typically travels a roadway. Autonomous driving systems may recognize these objects in a vehicle's environment and take appropriate and timely action to avoid collisions.

Additionally, autonomous driving systems may identify other indicators—such as traffic signals, traffic signs, and lane markings—that regulate vehicle movement (e.g., when the vehicle must stop and may go, a speed at which the vehicle must not exceed, where the vehicle must be positioned on the roadway, etc.). Autonomous driving systems may need to determine when a vehicle should change lanes, turn at intersections, change roadways, etc. As is evident from these examples, many factors may need to be addressed in order to provide an autonomous vehicle that is capable of navigating safely and accurately.

Autonomous vehicles that do not require a human driver can be used to assist in the transport of passengers or goods from one location to another. An important component of an autonomous vehicle is a sensory system that allows the vehicle to use cameras, radar, sensors, and other similar devices to perceive and interpret their surroundings. The perceptual system performs a number of decisions such as acceleration, deceleration, stopping, turning, etc. while the autonomous vehicle is moving. Autonomous vehicles may also use cameras, sensors, and global positioning devices to collect and interpret images and sensor data about their surrounding environment, such as parked cars, trees, buildings, and the like.

Information from the sensory system can be combined with highly detailed map information so that the vehicle computer can safely drive the vehicle in various environments. This highly detailed map information can describe the expected state of the vehicle environment, such as the shape and location of roads, traffic signals, and other objects. In this regard, information from the perception system and detailed map information can be used to assist the vehicle computer in making driving decisions including intersections and traffic signals.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a hill description. A full appreciation of the various aspects of the invention can be gained by taking the entire specification, claims, drawings, and abstract as a whole.

The present invention relates to an apparatus and method of Traffic signal system with various innovative features.

The present invention has been made to solve the mentioned problems, in which the old traffic lights were used and were used for centuries without the update in technology.

Accordingly, it is the first object of the present invention to provide an innovative traffic signal system where passersby will be shared with the latest information/news.

It is the second object of the present invention innovative traffic signal system which will have larger and brighter lighting panels.

It is also the primary objective of the invention to show the timer for each traffic light.

It is another objective of the invention that it has the camera that can rotate 180 degrees and will help to reduce crime and keep a lookout around the streets.

It is another objective of the invention to be used with the latest chips and technology.

It is also the objective of the system to provide parts that could be switched altered or improved to do similar or other functions, Like turning signal lights, portable lights or even any other solar-powered and smarter traffic devices. Others could even take some parts out to use technology in controlling traffic in other ways. It can also use connectivity amongst cars and traffic devices.

A further object is to use solar energy and run completely on it with backup batteries on placed inside the traffic lights panel. The traffic light also can be run on kinetic energy.

A further object is to provide built-in cameras that can read licenses plates and AI technology-based traffic in real-time instead of data

It is a further object of the present invention to provide, a new and improved method that is of a reliable system.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, FIGURES, and Claims.

### BRIEF DESCRIPTION OF DRAWING

non-limiting and non-exhaustive embodiments of the present invention are described with reference to the following drawings. The system and method of the present invention will now be described with reference to the accompanying flow chart drawing FIGURE, in which:

FIG. 1 is a top, front, and perspective view of the traffic signal panel as per preferred embodiments of the invention;

Skilled artisans will appreciate that elements in the figures are illustrated for simplicity and clarity and have not necessarily been drawn to scale. For example, the dimensions of some of the features in the FIGURES may be exaggerated relative to other elements to improve understanding of embodiments of the present invention. The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. The current invention as per its preferred embodiments aims to provide a traffic signal with multiple exemplary features.

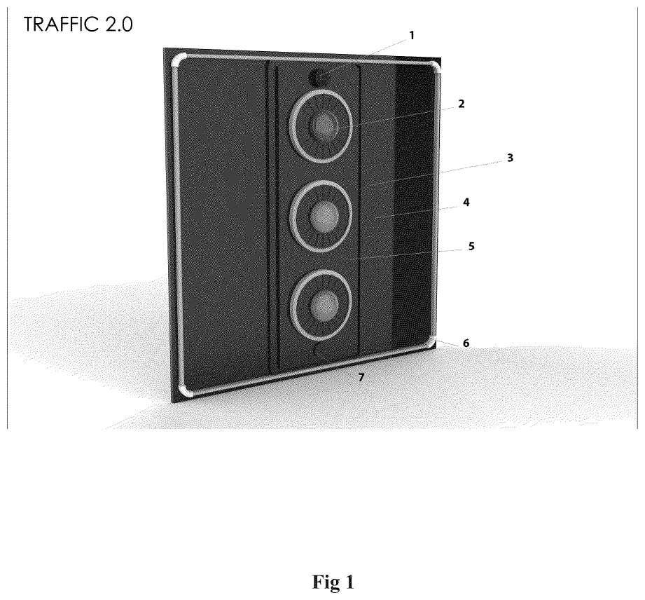

As per preferred embodiments of the invention, the assembly can be better understood by looking at FIG. 1. The FIG. 1 discloses Motion sensor (1), Digital Timer (2), Solar Panels (3), Backup Battery (4), Smart chips and other techs (5)m Better visible lights (6), and Camera (7), which are integral parts of the assembly.

For purposes of this invention, vehicle means any vehicle driven by an individual on a roadway such as the car, truck, large tractor, trailer truck and any other vehicle having at least four wheels, and also including two-wheeled vehicles, motorized two-wheel vehicles including motorcycles. Cyclists include anyone riding a non-motorized two-wheel vehicle such as a bicycle, mountain bicycle, racing bicycle etc. A pedestrian is any person who is crossing a crosswalk including a person who is handicapped in some way and is using an assistant to travel across the intersection.

The positioning of the traffic signal will be at the same eye—level as the traffic signal. The piezoelectric panels produce energy with the movement of pedestrians and vehicles.

The system as per its further embodiments will be providing information of the street/area that is the traffic congestion is high or low. Defined broadly, the present invention is a method for advising traffic at an nearby street or areas comprising: (a) means for capturing traffic light signal sequences and broadcasting the information within the radius of the selected intersection; (b) means for delivering audio and video messages to drivers and/or cyclists who are stopped at a red light and pedestrians on a sidewalk within visual range of the “DO NOT WALK” signal to advise drivers/pedestrians/cyclists of conditions on the road, sidewalks and other important information which drivers/pedestrians/cyclists are able to read because they are not occupied with driving/walking/cycling due to the fact that they are stopped at a red light and pedestrian “DO NOT WALK” signal.

The system as per its further embodiments will be equipped with a light that will help pedestrians at night. The system is designed with the latest technology and solar panels. The built-in battery, chips, AI technology using ABS durable plastic, metals LED's and other materials used in the process of creating, making or improving this traffic device. It can be duplicated in other ways as of creating this light.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I: A traffic signal panel comprising:
A motion sensor;
A digital timer;
a 180-degree camera;
a solar panel with batteries;
smart chips and other tech;
traffic light runs on kinetic energy; and
lights.
As per claim 1, the Data obtaining module, input terminal is connected with the 180-degree camera to monitor and alert the users on traffic congestions.
As per claim 1, a motion sensor module to obtain and analyze data based on real-time occurrences.
As per claim 1, built-in solar panels to keep the assembly in a working state.
As per claim 1, a digital tinier alerting the user on the time remaining for traffic to resume; and,
As per claim 1, smart chips and other technological advancements to provide weather and time updates to on-lookers.
